(19) United States
(12) Patent Application Publication
(10) Pub. No.: US 2005/0252411 A1
(43) Pub. Date: Nov. 17, 2005

(54) Organic solvent-based printing inks

(76) Inventors: Iain Frank Fraser, Kilbirnie (GB); Stuart Cook Niven, Ayrshire (GB); Joyce Wilcox, Renfrewshire (GB)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/523,240

(22) PCT Filed: Jul. 17, 2003
(86) PCT No.: PCT/EP03/07772

§ 371 Date: Jan. 19, 2005

(30) Foreign Application Priority Data
Jul. 26, 2002 (EP) 02405651.7

(51) Int. Cl. C09D 11/00; C09D 11/08

(52) U.S. Cl. 106/31.49; 106/31.5; 106/31.28; 106/31.57; 106/31.58; 106/31.4; 106/31.42

(57) ABSTRACT

An organic solvent-based printing ink composition which comprises a cationic dyestuff of the indole class, an organic solvent, an organic acid which preferably is a resin acid, soluble in the organic solvent, and optionally an organic pigment. The cationic dyestuff is formed (in situ) from its carbinol precursor. The compositions show for example high color strength and excellent rheological properties and can be used in publication or packaging gravure flexographic, lithographic or letterpress printing processes.

The present invention relates to organo-soluble compositions containing basic yellow dyes of the indole class as sole colourant or as toner (toning agent) for predominatly pigment based inks which are useful as organic solvent-based printing inks in e.g. publication gravure or packaging gravure, flexographic, letterpress or lithographic printing processes. The yellow dyes are prepared from their carbinol base precursors by reacting them with organic acidic components, before or during (in-situ) the process for preparing the prining inks.

The use of certain colour bases (carbinols) for the preparation of organic solvent-based inks is already disclosed e.g. in FATIPEC CONGRESS 1976, 13, 554 where dyes and associated carbinols of the triarylmethane, diarylmethane and xanthene families are combined with coloured pigment compositions containing a so-called printing resin. The use of indole dyes and their carbinols is not mentioned, and further, the effects, e.g. colour strength, can be visibly increased only by the addition of organo-soluble (touluene soluble) surfactants (e.g. dodecyl benzene sulfonic acid). The presence of surfactants, however, can cause both printing and fastness problems, and furthermore the use of surfactants limits the quantity of dye that can be used in the printing inks. The present invention does not require the use of such surfactive materials.

While the use of the carbinols (dye precursors) of the above-mentioned colour families was not fully convincing, it has now been found that by using a particular group of basic (yellow) indole dyes and their carbinol precursors for preparing organic solvent-based printing ink compositions, outstanding effects can be achieved.

Accordingly, it is the main object of the present invention to provide said printing ink compositions. Other objects of the present invention relate to processes for the preparation of these printing ink compositions as well as methods of using them. These and other objects of the present invention will be described in the following.

Therefore, in a first aspect, there is provided an organic solvent-based printing ink composition which comprises
(1) a cationic dyestuff of formula (1), 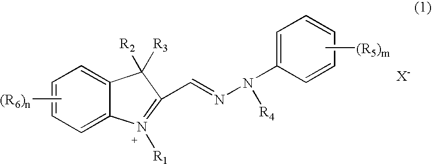
   or a mixture thereof,
wherein R₁-R₆ are independently of one another hydrogen, substituted or unsubstituted alkyl, alkoxy, cycloalkyl, aryl, heteroaryl or allyl, R₂ and R₃ may be combined together to form a ring, further R₅ and R₆ are independently of one another halogen, cyano, nitro, aryloxy, alkenyl, alkenoxy, alkoxcarbonyl, aryloxycarbonyl, acyloxy, acyl, alkylthio, arylthio, acylamino, alkylsulfonyl, arylsulfonyl or thiocyano, any two of R₅ or any two of R₆ may be combined together to form a homocyclic or heterocyclic aromatic or non-aromatic ring, m is an integer of 1 to 5, n is an integer of 1 to 4 and X⁻ is an organic anion,
(2) an organic solvent,
(3) an organic resin acid, or a salt thereof, soluble in the organic solvent, and
(4) optionally a pigment.

The substituents R₁-R₆ in formula (1) are independently of one another hydrogen (hydrogen means (for R₅/R₆) that the phenyl rings are unsubstituted, i.e. they contain 5 and 6 hydrogen atoms, respectively); further substituted or unsubstituted alkyl and alkoxy which comprises species of e.g. 1 to 20 carbon atoms, preferably of 1 to 10 carbon atoms, which may be linear or branched. Examples are methyl, ethyl, propyl, butyl, pentyl, hexyl, heptyl, octyl, nonyl, decyl, dodecyl, hexadecyl, octadecyl and the corresponding isomers. The alkoxy species can be listed analogously. Preferred are the lower alkyl/alkoxy (C₁-C₄) species, and mostly preferred are methyl and methoxy.

As to the substituted alky and alkoxy radicals (preferences with regard to the chain lengths as mentioned above) there can be mentioned hydroxyalkyls, halogeno-alkyls (fluoro-, chloro-, bromo-, iodo), aminoalkyls, cyanoalkyls and arylalkyls, wherein the aryl moiety may be further substituted (e.g. lower alkyl and alkoxy, halogeno, hydroxy, cyano, amino, carboxy, carbonamido), on the one hand, and e.g. arylalkoxy (aryl substituted as mentioned above), on the other hand.

The cycloalkyl radicals may contain 5 to 10 ring carbon atoms, preferred are the C₅-C₇ species, viz. cyclopentyl, cyclohexyl, and cycoheptyl, cycohexyl being mostly preferred. Possible substituents may be lower alkyl radicals, preferably methy and ethyl.

The aryl radicals may contain e.g. 6 to 10 cabon atoms, preferably comprising phenyl or naphthyl, optionally substituted by hydroxy, halogeno (fluoro-, chloro-, bromo-, iodo), amino, cyano, carboxy, carbonamido, or sulfo and sulfonamido.

The heteroaryl radicals preferably contain 5 to 10 ring atoms, comprising one or more, e.g. 1 to 3, nitrogen, oxygen or sulfur atoms. Examples may be imidazolyl, oxazolyl, thiazolyl, thienyl, pyrrolyl, pyrazolyl, triazolyl, pyridinyl, pyridazinyl, pyrimidyl, triazinyl, benzimidazolyl, benzoxazolyl and quinoxalinyl, including isomeric forms. With regard to the monocyclic radicals, those of 5 or 6 ring atoms are preferred.

Substituents may be selected from e.g. hydroxyl, halogen, amino and substituted amino, cyano, carboxyl (including esters and amides), sulfo, sulfoamide, lower alkyl.

The allyl radical may be optionally substituted by lower alkyl, halogen or cyano.

R₂ and R₃ may be combined together to form a 5 to 7-membered homocyclic or heterocyclic ring, such as cyclopentane, cyclohexane or tetrahydrofurane.

Further, the subtituents R₅ and R₆ are independently of one another halogen, cyano, nitro, aryloxy, alkenyl, alkenoxy, alkoxcarbonyl, aryloxycarbonyl, acyloxy, acyl (RCO—), alkylthio, arylthio, acylamino including carboxylamino (carbonamido) R—CO—NH— (R is.g. hydrogen, alkyl or phenyl) and sulfonylamino (sulfamido) R₁—SO₂—NH— (R₁ is e.g. alkyl or phenyl), alkylsulfonyl, arylsulfonyl or thiocyano, wherein the number of carbon atoms may be up to 10; depending on the the radicals the lower limit may be 1 (alkyl) or 6 (aryl).

Any two of R₅ or any two of R₆ my be combined together to form with the rings to which they are attached, annellated ring systems such as homocyclic or heterocyclic aromatic or non-aromatic mono- or bicyclic rings. The annellated rings may contain 6 to 10 ring atoms, and preferably are 5- or 6-membered saturated or unsaturated homocyclic rings (phenylene, cyclopentylene, cyclohexylene); or they contain as heterocyclic rings nitrogen, oxygen and/or sulfur atoms; examples are thienyl, furfuryl, pyrimidyl, pyridinyl, or the group —CH₂—O—CH₂—. For substituents R₅ and R₆—other than hydrogen—index m preferably is 1 to 3 or 1 or 2; index n preferably is 2, and mostly preferred 1. Further preferred are the unsubstituted phenyl rings, i.e. wherein R₅ and R₆ are hydrogen.

The anion X⁻ is generally derived from organic acids, such as fatty acids of 8 to 24, preferably 8 to 18, carbon atoms which are linear of branched, saturated or unsaturated and include caprylic acid (C₈), pelargonic acid (C₉), capric acid (C₁₀), lauric acid (C₁₂), myristic acid (C₁₄), palmitic acid (C₁₆), stearic acid (C₁₈), mono-unsaturated oleic acid (C₁₈), di-unsaturated linoleic acid (C₁₈), tri-unsaturated linolenic acid (C₁₈), and erucic acid (C₂₂). The mentioned fatty acids may be unsubstituted or, furthermore, substituted, for example by hydroxy or chlorine, preferably hydroxy. Preferably, the mentioned carboxylic acids are unsubstituted.

Preferably, the fatty acids are saturated or mono-unsaturated C₁₂-C₁₈fatty acids.

Further acids may be 2-(2,4-ditert.-amylphenoxy)-butyric acid; phosphoric/phosphonic acids, such as the monolauryl ester of of phosphoric acid, the dioctyl ester of phosphoric acid or dodecyphosphonic acid; sulfonic acids, such as hexadecane sulfonic acid, alkyl substituted benzene sulfonic acids, such as p-toluene sulfonic acid or p-octylbenzene-sulfonic acid; naphthalene sulfonic acid or alkyl substituted naphthalene sulfonic acids; further phenolic acids, such as 3,5-di-tert.butylsalicylic acid; others are carboxylic acids having an unsubstituted or C₁-C₄alkyl-substituted C₅-C₇cycloalkyl skeleton, for example 4-cyclohexylbutyric acid, 3-cyclohexylpropionic acid, cyclohexylacetic acid, cyclohexanecarboxylic acid, 4-methylcyclohexanecarboxylic acid and cyclopentanecarboxylic acid.

Preferably the anion X⁻ is derived from resin acids, i.e., carboxylic acids based on terpenes, for example acyclic, monocyclic or bicyclic C₁₀terpenes, acyclic, monocyclic, bicyclic or tricyclic C₁₅sesquiterpenes, acyclic, monocyclic or tricyclic C₂₀diterpenes, especially tricyclic C₂₀diterpenes, e.g. abietic acid, dihydroabietic acid and tetrahydroabietic acid. Preferred resin acids are colophony (main component abietic acid), rosin acid and abietyl resin as well as derivatives thereof, in particular chemically modified rosin acids.

The rosin acids include e.g. gum rosin, wood rosin, talloil rosin and chemically modified species, such as halogenated, sulfonated, phosphonated or nitrated rosins; further included are disproportionated, hydrogenated, dimerised, polymerised or part-polymerised rosins; and also rosin modified esters, such as maleinized rosin, pentaerythritol rosin ester and rosin-modified phenolic resin.

The chromophores of the cationic (basic) dyes of formula (1) are e.g. compiled as C.I. Basic Dyes in The Colour Index (C.I.), issued by the Society of Dyers and Colorists and The American Association of Textile Chemists and Colorists. Details of the dyes are disclosed there.

Component (2) of the inventive gravure printing ink compositions is an organic solvent, (comprising the whole range from polar to non-polar organic solvents), which may be selected from the group consisting of optionally halogenated aliphatic hydrocarbons, optionally halogenated aromatic hydrocarbons, preferably of the benzene series, dialkyl and cyclic ethers, glycol ethers, polyalkylene glycols, polyalkylene glycol ethers, alcohols (mono- and poly-hydric), esters, ketones, amides, nitrogen containing heerocyclic compounds, solubilising ink vehicle components, and monomers (acrylate monomers), as well as mixtures thereof.

The aliphatic hydrocarbons are preferably those having a boiling point of about 75 to 180° C., though distillates within the boiling range of 180 to 400° C. are also highly applicable.

Typical examples are heptane, octane, nonane, decane and like normal paraffins, isootane and like iso-paraffins; ligroin, petroleum spirit, and refined gasoline, 1-heptene, 1-octene, 1-nonene. Examples of the higher boiling distillates are of the range of 240 to 270° C. and 280 to 350° C., respectively.

The preferred aromatic hydrocarbons are those of the benzene series, particularly unsubstituted or C₁-C₄-alkyl substituted benzenes, such as benzene, xylene, and preferably toluene; and further halogenated benzenes, such as the the chlorobenzenes (mono-, di- and tri-).

As glycolethers there can be used e.g. ethylene glycol monomethyl and monoethylether, dipropylene glycol, ethyldiglycol, butyldiglycol or phenylglycol.

Typical alcohols are e.g. C₁-C₈ alcohols, such as methanol, ethanol, n-propanol, iso-propanol, and ethoxypropanol and also the more non-polar ones which are e.g. C₄-C₈ alcohols, such as n-butanol, isobutanol, sec-butanol, tert-butanol, or n-hexanol as well as the corrosponding isomers and further cyclohexanol and benzyl alcohol.

Dialkylethers are e.g. methylethylether or diethylether, examples of cyclic ethers are tetrahydrofuran and dioxan.

Representative esters are the acetates, such as ethyl acetate, propyl acetate or butylacetate. Suitable ketones are acetone, methylethyl ketone, methylisobutyl ketone, diacetonalcohol, cyclohexanone and acetophenone.

Preferred species of the halogenated aliphatic hydrocarbons are dichloromethane, trichloromethane, tetrachloromethane, trichloroethane, tetrachloroethane, trichloroethylene, tetrachloroethylene.

Amides are e.g. dimethylformamide or dimethyl acetamide; a nitrogen-containing heterocyclic compound is e.g. N-methyl-2-pyrrolidone or 1,3-dimethyl-2-imidazolidone. Polyalkylene glycols, preferably a low molecular weight polyethylene glycol having a molecular weight of from 100 to 800, are e.g. diethylene glycol, triethylene glycol, tetraethylene glycol, polyethylene glycol 200, polyethylene glycol 300, polyethylene glycol 400 or polyethylene glycol 600, especially having a molecular weight of from 150 to 400, or a low molecular weight polypropylene glycol, e.g. dipropylene glycol, tripropylene glycol, polypropylene glycol P 400 or polypropylene glycol P 425.

Polyalkylene glycol ethers are e.g. C₁-C₄alkyl ethers of a polyalkylene glycol, e.g. diethylene glycol monobutyl ether, 2-(2-methoxyethoxy)ethanol, 2-(2-ethoxyethoxy)ethanol, 2-[2-(2-methoxyethoxy)ethoxy]ethanol or 2-[2-(2-ethoxyethoxy)ethoxy]ethanol.

Glycols or thioglycols are e.g. C₂-C₆alkylene glycols or a thioglycols, such as ethylene glycol, propylene glycol, butylene glycol, 1,5-pentanediol, thiodiglycol, hexylene glycol.

Polyhydric alcohols and their ethers are e.g. glycerol or 1,2,6-hexanetriol and a C₁-C₄alkyl ether of such as 2-methoxyethanol or 1-methoxypropan-2-ol.

Monomers of UV-curing inks also class as solvents in this context. Typical examples are, but not exclusively, acrylate monomers, such as 1,4-butanediolacrylate, propoxylated glycerol triacrylate and pentaerythritol triacrylate. It is also possible that ink vehicle components or excess organic acid can act as solvent to the reaction.

Preferred organic solvents (2) are those selected from the group consisting of optionally halogenated aliphatic hydrocarbons, optionally halogenated aromatic hydrocarbons, preferably of the benzene series, dialkyl ethers, glycol ethers, (non-polar) alcohols, esters, ketones, solubilising ink vehicle components, monomers (acrylate monomers) and mixtures thereof.

The organic acids which constitute component (3) of the inventive gravure printing ink composition are those mentioned hereinbefore when defining their anions X⁻ as those derived from resin acids. Mixtures of acids can also be used.

It is preferable that the acids used are not surfactive in nature and are perfectly compatible with the ink solvent and binders (ink vehicles).

Component (4) of the inventive compositions preferably relates to organic pigments which comprise, but not exclusively, such pigments as monoazo, disazo, naphthol, dioxazone, azomethin, azocondensation, metal-complex, nitro, perinone, quinoline, anthraquinone, benzimidazolone, isoindoline, isoindolinone, quinacridone, hydroxyanthraquinone, aminoanthraquinone, anthrapyrimidine, indanthrone, flavanthrone, pyranthrone, antanthrone, isoviolanthrone, diketopyrrolopyrrole, carbazole, perylene, indigo or thioindigo pigments. Mixtures of the pigments may also be used.

Preferred are organic pigments of the following chemical classes:
Monoazo, disazo, azomethin, naphthol, and metal-complex pigments (e.g. phthalocyanines).

For further details as to the organic pigments reference is made to Industrial Organic Pigments, W. Herbst, K. Hunger, 2^{nd} edition, VCH Verlagsgesellschaft, Weinheim, 1997.

Optionally the organic pigments can be mixed with inorganic pigments which include among others titanium oxide pigments, iron oxide and hydroxide pigments, chromium oxide pigments, spinel type calcined pigments, lead chromate pigments, carbon black and Prussian Blue.

Alternatively, full replacement of organic pigments by inorganic ones is also possible.

The inventive printing ink compositions (gravure printing ink compositions) can be prepared by a process which comprises mixing together
(a) a carbinol dye precursor of the formula (2) 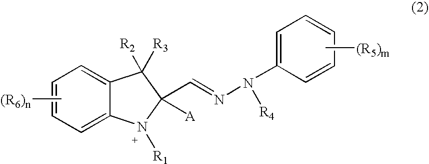
   or a mixture thereof, dissolved or dispersed in an organic, preferably a non-polar organic solvent,
wherein R₁-R₆ are independently of one another hydrogen, substituted or unsubstituted alkyl, alkoxy, cycloalkyl, aryl, heteroaryl or allyl, R₂ and R₃ may be combined together to form a ring, further R₅ and R₆ are independently of one another halogen, cyano, nitro, aryloxy, alkenyl, alkenoxy, alkoxcarbonyl, aryloxycarbonyl, acyloxy, acyl, alkylthio, arylthio, acylamino, alkylsulfonyl, arylsulfonyl or thiocyano, any two of R₅ or any two of R₆ may be combined together to a homocyclic or heterocyclic aromatic or non-aromatic ring, A is —OR, —N(R)₂, —N(R)COR, —N(R)SO₂R, —SR, —S(O)R, —O₂CR, —N(R)CON(R)₂, —OCON(R)₂, —SO₂N(R)₂ or —N(R)COOR, wherein R is R₁, m is an integer of 1 to 5 and n is an integer of 1 to 4, with
(b) a solution of an organic resin acid, dissolved in an organic, preferably a non-polar organic solvent, and with
(c) optionally a pigment.

Preferably, R₁-R₆ in the carbinol dye precursor of formula (2) are independently of one another hydrogen, unsubstitued or substituted alkyl or alkoxy of 1 to 10 carbon atoms, cycloalkyl of 5 to 10 carbon atoms, aryl of 6 to 10 carbon atoms, heteroaryl of 5 to 10 atoms, comprising one or more nitrogen, oxygen or sulfur atoms as ring members, or allyl, R₂ and R₃ may be combined together to form a 5 to 7-membered ring, and A, m and n have the meanings indicated. Mostly preferrred as substituent A is —OH.

As to further preferences of the substituents and explanations given, reference is made to those definitions provided for them in formula (1).

As an alternative to this process, the preparation can be performed as follows:

This process comprises mixing together
(a) a carbinol dye precursor of the formula (2) with
(b) a solution of an organic acid, preferably a resin acid, dissolved in an organic (polar or non-polar) solvent,
evaporating off the solvent (under reduced pressure) from that mixture until a dry mixture is obtained, and redissolving the dry mixture in an organic solvent (organic non-polar solvent) compatible with the desired ink medium, and with
(c) optionally an (organic) pigment.

The solvent for the solution (b) must be a solvent wherein both the starting materials (carbinol/resin acid) are sufficiently soluble to allow reaction. The organic solvent designated as preferred herein before are most suitable, in particular the ketones (acetone), dialkyethers (diethylether) and the halogenated hydrocarbons (dichloromethane, chloroform).

Further these solvents can be easily removed from the reaction mixture.

The solvents to be used in the redissolving step should be selected from those of the mentioned solvents as preferred which are known as so-called ink solvents, such as aromatic hydrocarbons (toluene), aliphatic alcohols (methanol, ethanol) and esters (ethyl acetate).

Further, the inventive process additionally comprises mixing a so-called ink vehicle with the combined dry, or wet, or redissolved components (a), (b) and optionally (c).

These ink vehicles which are in general any known binders include for example long-oil-, medium-oil- or short oil-alkyd resins, phenol-modified alkyd resins, phenolic resins, rosin-modified phenolic resins, metal resinates, such as copper, zinc or magnesium resinate, petroleum resins, (cyclic) hydrocarbon resins, such as terpene or terpene-phenolic resins, resins based on acrylics, styrenes and vinyl polymers, melamine and epoxy resins, distillate and vegetable oils, and further nitrocellulose, cellulose acetate propionate, polyamide, polyvinylbutyral, polyvinylalcohol, polyvinylacetate, acrylic, propionated acrylic, polyvinylchloride, polyvinyldichloride, chlorinated polyolefin, dimerised and polymerized rosins, rosin esters, rosin modified maleic, fumaric and phenolic resins, epoxide and maleic resins.

Alternatively, the inventive process may be carried out by dry mixing components (a), the organic (resin) acid (mentioned in component (b)) and optionally (c), and then co-dissolving this mixture in an organic solvent, preferably a non-polar organic solvent as hereinbefore defined.

The wet blend (co-dissolved mixture—as solution or in concentrated form) is a further object of the present invention.

The dry mixture of components (a), the organic (resin) acid, and optionally (c) used according to this alternative is a further object of the present invention.

Alternatively, the inventive process compomprises dry mixing components (a), the organic (resin) acid, and optionally (c), and an ink vehicle, and then co-dissolving this mixture in an organic solvent, preferably a non-polar organic solvent.

The dry mixture of components (a), the organic (resin) acid, and optionally (c), and an ink vehicle used according to this alternative is a further object of the present invention.

The wet blend (co-dissolved mixture—as solution or in concentrated form) is a further object of the present invention.

As a further alternative, the inventive process comprises incorporating components (a), the organic (resin) acid, and optionally (c) separately or as dry mix into preformed ink vehicles. This process can be carried out by extruding the components (a), the organic (resin) acid, and optionally (c) separately or as dry mix into high solids dispersions, solutions or pastes of the ink vehicle.

The extrusion products obtained according to this process are a further object of the present invention.

The organic/inorganic pigments (c) are those as defined hereinbefore as component (4).

Processing can also be carried out by predissolving the organic resin acid in the molten ink vehicle or an ink vehicle component by application of shear and/or heat if necessary. Into this medium the carbinol precursor is dissolved by the application of shear and/or heat if necessary. Alternatively, both carbinol precursor and organic resin acid can be co-dissolved into the ink vehicle in one step.

Mostly preferred are compounds of formula (2) to be used in the inventive process, wherein R₁-R₄ are methyl, R₅ is methyl or methoxy (m is 1), two R₅ together form —O—CH₂—O—CH₂—, R₆ is hydrogen, A is —OH and n is 1.

Further, the inventive process is carried out, wherein components (b) and (c) together constitute a resinated pigment.

The essential components and the optional components can be mixed by any known method using a ball mill, sand mill, bead mill, attritor, continuous horizontal medium dispersing machine, two-roll mill, three-roll mill, pressure kneader, or extruder; further by manual or mechanical shaking, or by low or high shear stirring.

The conventional process for preparing a pigment based printing ink composition may be carried out in two steps:
(I) The dissolving of the ink vehicle in the organic solvent (non-polar organic solvent).
(II) The dispersion of the pigment within the dissolved ink vehicle.
   Step (II) normally requires a far higher level of shear than step (I) and results in the generation of heat.

It has now been found that preparing the inks according to the present invention is extremely flexible which can be shown by the following manufacturing methods all of which produce identical inks:
The organic (resin) acid is fully dissolved in the organic solvent (non-polar organic solvent) followed by the carbinol. The dye solution thus produced is added to a previously prepared ink vehicle solution.
The organic (resin) acid and carbinol are dry mixed together and then codissolved in the organic solvent (non-polar organic solvent). The dye solution thus produced is added to a previously prepared ink vehicle/toluene solution.
The organic resin acid, carbinol and ink vehicle resin are dry mixed together and then co-dissolved in the organic solvent (non-polar organic solvent).

In all three cases the level of shear required is similar to that necessary for normal dissolving of ink vehicle resins and far less than that required for pigment dispersion. Due to the lower shear, the generation of heat within the inks is much reduced.

It is therefore possible to produce a finished coloured ink within the same timescale and using similar shear to that normally required for the simple dissolving of the ink vehicle resin.

Due to the simplicity of reaction, many processing possibilities are now open. The production of a coloured ink can now be carried out on any equipment capable of generating low levels of shear. The traditional high shear approach to pigment dispersion is not required though the possibility of carrying out both in tandem is included.

Combination of the carbinol with the resin acid can be carried out in an extruder with a suitable carrier system. This carrier system may be a solvent or a concentrate of a suitable ink vehicle. Reaction of the carbinol may be achieved during the extrusion process though this is not essential as this can occur during the later dispersion of the concentrate within the ink solvent.

The carbinol approach to colouration can be used in conjunction with traditional pigment methodology. As such, further possibilities for both ink and pigment processing are opened.

In general, many conventional solvent based liquid inks do not contain high levels of abietyl resins (resin acid) as part of their compositions. Such resins are commonly used in pigments destined for use in distillate or vegetable oil based offset lithographic inks. In addition to improving the performance of the pigment within the ink system further advantages are also gained. The abietyl resin treatments act to reduce aggregation of the pigment during production and drying. Abietyl resin containing pigments in general can be produced more quickly and more reproducibly while also giving products of much reduced aggregation. As a result the dispersibility of the product and the final performance are often superior.

Conventionally, many solvent based liquid inks, e.g. toluene based publication gravure inks, have not utilised abietyl resin containing pigments as the solution of this material into the ink vehicle causes increased viscosity. However, as abietyl resins are acidic in nature, the possibility now exists to use this material as a converting agent for carbinol dye pre-cursors. Thus the pigment can be considered as a carrier for the carbinol-converting agent. The carbinol can also be considered as an agent that reduces the traditional problems of using resinated pigments in toluene systems. The high colour strength of the resulting dyestuff allows the use of a lower pigmentation level thus reducing viscosity. The possibility also exists for improved gloss thus allowing an equivalent reduction in binder level.

The inventive compositions may be employed in any amount effective for the intended purpose. In general good results have been obtained with compositions which comprises by weight 0.1-50% of component (1), 1-95%, preferably 5-95% % of component (2), 0.1-75%, preferably 0.1 to 50%, of component (3), and 0-50% of component (4).

Preferably the concentrations may be: 15-40% of component (1), 40-60% of component (2), 20-50% of component (3), and 0-50% of component (4).

The compositions may be generally embodied in the following two forms:
(A) A composition containing components (1) to (3) but no pigment—this composition can be used itself as printing ink, e.g. gravure printing ink (whole colourant composition).
(B) A composition containing components (1) to (4) wherein components (1) to (3) serve as toning agents for the shading, tinting and brightening of predominatly pigment (4) based printing inks (partial colourant composition).

The organic resin acid of component (3) is the excess acidic component from the reaction with the carbinol precursor. Though most experimental work has required high levels of the acidic component to push the reaction forward. It is possible that a 1:1 molar reaction with the carbinol can be done.

Thus component (3) may be present at 0%. However, usually there is a certain excess that can be defined as above about 0.2%. It is also used possible that the excess acidic component is used to make up the majority of the binder resin composition (e.g. gravure binder resins where the binder resins are often derivatives of resin acids, such as metal resinate salts) and therefore can become an amount of up to 75%, preferably 50%.

The excess amount of component (3) can be defined, therefore, as being 0.1 to 75%, preferably 0.1 to 50%.

Furthermore, the printing inks may in addition comprise customary additives known to those skilled in the art.

Typical additives include drying enhancers, drying inhibitors, non-coloured extenders, fillers, opacifiers, antioxidants, waxes, oils, surfactants, rheology modifiers, wetting agents, dispersion stabilizers, strike-through inhibitors and anti-foaming agents; further adherence promoters, cross-linking agents, plasticisers, photoinitiators, deodourants, laking agents and chelating agents.

Such additives are usually used in amounts of from 0 to 5% by weight, particularly from 0 to 2% by weight, and preferably from 0.01 to 1% by weight, based on the total weight of the printing ink (gravure printing ink and others) composition.

The inventive printing ink compositions can be used in the corresponding processes for the printing of flat substrates such as publication and packaging gravure, lithographic, letterpress and flexographic printing. These processes are further objects of the present invention.

These processes are used, for example but not exclusively, for the printing of magazines, newspapers, magazine supplements, catalogs, posters, packaging materials, food wrappings and containers, paper, foil and plastic films.

The present invention is hereafter further described with reference to particular examples thereof. It will be appreciated that these examples are presented for illustrative purposes and should not be construed as a limitation on the scope of the invention as herein described.

In the following examples, quantities are expressed as parts by weight or percent by weight, if not otherwise indicated.

The temperatures are indicated in degrees centigrade.

### EXAMPLES

### Example 1

11.2 g of tall oil rosin is added to 14.3 g toluene and shaken until dissolved. To this solution, 4.5 g of the carbinol base of C.I. Basic Yellow 29 is added and shaken until full solution is achieved. 20.0 g of this dyestuff solution is then combined with 80 g of a 50% toluene solution of rosin modified phenolic resin.

### Example 2

9.0 g of tall oil rosin is added to 15.0 g toluene and shaken until dissolved. To this solution, 6.0 g of the carbinol base of C.I. Basic Yellow 28 is added and shaken until full solution is achieved. 20.0 g of this dyestuff solution is then combined with 80 g of a 50% toluene solution of rosin modified phenolic resin.

### Comparative Example A

A traditional pigment based publication gravure ink is prepared by beadmilling 7.0 g IRGALITE Yellow PR 26® (C.I. Pigment Yellow 12 composition) into 70.0 g of a 50% rosin modified phenolic resin solution in toluene and a further 23.0 g toluene.

### Comparative Example B

A traditional pigment based publication gravure ink is prepared by beadmilling 7.0 g PERMANENT Yellow DHG N20® (C.I. Pigment Yellow 12 composition) into 70.0 g of a 50% rosin modified phenolic resin solution in toluene and a further 23.0 g toluene. The prints of Comparative Example B are moderately more red shade than Comparative Example A.

Strength gloss and transparency versus pigment

| | Comparative | |
|---|---|---|
| | Example A | Example 1 |
| COLOURANT | 7.0% | 3.0% |
| CONTENT (BY | | |
| WEIGHT) | | |
| STRENGTH | 100% | 100-105% |
| GLOSS | standard | slightly-moderately higher |
| TRANSPARENCY | standard | moderately-considerably |
| | | higher |

Shade Match by Ink Blending

| | Comparative | 80/20 BLEND OF EXAMPLE |
|---|---|---|
| | Example B | 1/EXAMPLE 2 |
| COLOURANT | 7.0% | 2.4% and 0.8% respectively |
| CONTENT (BY | | |
| WEIGHT) | | |
| STRENGTH | 100% | 105% and very slightly |
| | | cleaner |
| GLOSS | standard | moderately higher |
| TRANSPARENCY | standard | moderately higher |

Colour Enhancement of Gravure Pigment

| | | 75/25 BLEND OF EXAMPLE 1 |
|---|---|---|
| | COMPARATIVE | AND COMPARATIVE |
| | EXAMPLE A | EXAMPLE A |
| COLOURANT | 7.0% | 5.2% and 1.0% respectively |
| CONTENT (BY | | |
| WEIGHT) | | |
| STRENGTH | 100% | 125% |
| GLOSS | standard | as standard |
| TRANSPARENCY | standard | slightly-moderately higher |

Fastness Versus Pigment

| PRINT FASTNESS | COMPARATIVE | |
|---|---|---|
| PROPERTY | EXAMPLE A | EXAMPLE 1 |
| LIGHT (BLUE WOOL | 3 | 3 |
| SCALE - 72 HOURS) | | |
| SWEAT | 5 | 5 |
| SALIVA | 5 | 5 |

Rheology

### Example 3

The methodology of Example 1 is repeated replacing the 80.0 g of 50% toluene/phenolic medium with 70.0 g and 10.0 g toluene.

| FLOW | COMPARATIVE | | |
|---|---|---|---|
| MEASUREMENT | EXAMPLE A | EXAMPLE 1 | EXAMPLE 3 |
| ZAHN CUP No. 2 | 51 | 65 | 26 |
| ZAHN CUP No. 3 | 17 | 19 | 9 |

The gloss, strength and transparency of Example 3 are identical to Example 1.

Dye Solution Manufacture Using Alternative Rosins

### Example 4

11.2 g tall oil rosin is dissolved in 17.3 g toluene by shaking. 4.5 g of the carbinol base of Basic Yellow 29 is then added and shaking continued until full solution is achieved.

### Example 5

Example 4 is repeated where tall oil rosin is replaced by disproportionated rosin.

### Example 6

Example 4 is repeated where tall oil rosin is replaced by hydrogenated rosin.

### Example 7

Example 4 is repeated where tall oil rosin is replaced by gum rosin.

### Example 8

Example 4 is repeated where tall oil rosin is replaced by maleic modified rosin.

### Comparative Example C

Example 4 is repeated where tall oil rosin is replaced by oleic acid.

### Comparative Example D

Example 4 is repeated where tall oil rosin is replaced by dodecylbenzenesulphonic acid.

Comparison of Examples 4-8/Comparative Examples C and D

Examples 4 to 8 all give full coloured solutions indicating effective conversion of the carbinol and compatability with toluene. Even without the addition of an ink vehicle, the film-forming properties and gloss of Examples 4 to 8 is such that printing can be achieved. Only very mild shade differences are seen between these examples.

While the conversion of the carbinol is as effective as in Examples 4 to 8, much reduced gloss is obtained with Comparative Examples C and D. The prints from C and D remain tacky for a longer period of time and the resistance to moisture is also greatly reduced in comparison with Examples 4 to 8.

Other Rosin Acids Give Useable Dyestuff Solutions:

### Example 9

Example 4 is repeated where tall oil rosin is replaced by dimerised rosin.

### Example 10

Example 4 is repeated where tall oil rosin is replaced by polymerised rosin.

Processing Advantage:

### Example 11

In a screw-cap jar, 11.2 g tall oil rosin is dissolved in 14.3 g toluene by shaking. 4.5 g Basic Yellow 29 carbinol base is added and dissolved by shaking. 20 g of this solution is then taken and added to 80 g of a 50% solution of rosin modified phenolic resin in toluene.

### Example 12

In a screw-cap jar, 11.2 g tall oil rosin is dry mixed with 4.5 g C.I. Basic Yellow 29 carbinol base and 14.3 g toluene then added. Full solution is achieved by shaking. 20 g of this solution is then taken and added to 80 g of a 50% solution of rosin modified phenolic resin in toluene.

### Comparative Example E

In a screw-cap jar, 50 g rosin modified phenolic resin is added to 50 g of toluene. 7 sessions of 4 minutes are required on a mechanical shaker at 1000 rpm to achieve full solution.

### Example 13

In a screw-cap jar 7.5 g tall oil rosin, 3 g C.I. Basic Yellow 29 carbinol base and 40 g of rosin modified phenolic resin are dry mixed then 49.5 g toluene is added. 7 sessions of 4 minutes are required on a mechanical shaker at 1000 rpm to achieve full solution.

The inks produced in Examples 11, 12 and 13 display identical properties. The final compositions of the three final inks are identical. The ink in Example 13 can be produced with the same level of energy input as the resin solution in Comparative Example E.

Comparative Processing Examples with Pigment:

### Comparative Example F

In a screw-cap jar 7.5 g tall oil rosin, 3 g Irgalite Yellow PD 4071 (Ciba Pigment Yellow 12 composition tailored for publication gravure, similar to Irgalite Yellow PR 26—Comparative Example A) and 40 g rosin modified phenolic resin are dry blended then 49.5 g toluene added. The mixture is then subjected to the same shaking process as used in Example 13.

### Comparative Example G

Comparative Example F is repeated with the inclusion of 200 g 1.7-2 mm glass beads to give a far higher level of shear.

### Comparative Example H

Comparative Example G is repeated with the tall oil rosin omitted and replaced by a further 7.5 g rosin modified phenolic resin. This sample replicates the total solids and colourant level in Example 13 though is carried out with higher shear.

### Comparative Example J

Comparative Example G is repeated with the pigment charge increased to 7.5 g in an attempt to match the colour strength possible from the Example 13 ink.

### Results of Example 13 Against Comparative Examples F to J

Comparative Example F shows poor dispersion of the colourant with severe settled solids in the vessel.

Comparative Example H contains lumps of undispersed resinous material.

Comparative Example J has congealed and is far too thick for manipulation by normal toluene-based ink techniques. Incomplete resin dispersion is also noted which does not improve on a further 3 sessions of 4 minutes on the mechanical shaker.

Comparative examples G, H and J are extremely hot (cannot be held comfortably in the hand) while Example 13 and Comparative Example F are only mildly warm to the touch.

Dispersion Level by Microscope (×100 Magnification) Assessment.

Example 13 is a complete solution.

Comparative Example F contains large quantities of over-sized undispersed particles.

Comparative Examples G and H contain a significant quantity of finer undispersed particles.

Comparative Example J contains both the large quantity of over-size particles and the significant amount of undispersed finer material.

Hegman Gauge Readings (0-100 Micron)

With this level of dispersion analysis, recordings are made of the points where 3 (three) different forms of disturbance to the ink film are first observed. Values between 0 and 8 are assigned where lower figures indicate earlier disturbance and larger particle size.
Example 13—8/8/6.5
Comparative Example F—5/1/1
Comparative Example G—8/6.5/3.5
Comparative Example H—8/6.5/3.5
Comparative Example J—8/7/4

### Example 14

5.0 g tall oil rosin and 2.0 g C.I. Basic Yellow 29 carbinol base are added to a mixture of 18.25 g ethanol, 6.125 g ethyl acetate and 1.75 g diacetonealcohol then shaken till dissolved. 21.125 g of a nitrocellulose ink medium containing 20% solids in a 4:1 ethanol:ethyl acetate blend is then added and shaken till full solution is achieved. The ink prepared in this manner contains 3.68% colourant.

### Comparative Example K

A conventional pigment based nitrocellulose ink is prepared using IRGALITE Yellow B3L and the mix of solvents as used in example 14 by mechanical shaking in a sealed vessel with glass beads. The ink prepared in this manner contains 9% pigment.

### Example 15

5.0 g tall oil rosin and 2.0 g C.I. Basic Yellow 29 carbinol base are added to a mixture of 24.375 g ethyl acetate and 1.75 g diacetonealcohol and shaken till dissolved. 21.125 g of a nitrocellulose ink medium containing 20% solids in ethyl acetate is then added and shaken till full solution is achieved.

### Comparative Example L

A conventional pigment based nitrocellulose ink is prepared using IRGALITE Yellow B3L and the mix of solvents as used in example 15 by mechanical shaking in a sealed vessel with glass beads. The ink prepared in this manner contains 9% pigment.

Results

In both cases (examples 14 and 15), despite the lower levels of colourants incorporated, the dyestuff based inks give superior strength in comparison with the pigment equivalents. Furthermore, the dyestuff based inks give moderately improved gloss and vastly increased transparency.

### Blend of Example 14 and Comparative Example K

A 3:1 ink blend of Comparative Example K and Example 14 is prepared. This ink gives roughly 5% more colour strength than the ink based on Comparative Example K alone despite the replacement of pigment with a much lower level of dyestuff colourant.

### Blends of Example 15 and Comparative Example L

A 9:1 ink blend of Comparative Example L and Example 15 is prepared. This ink gives similar colour strength to the ink based on Comparative Example L alone despite the replacement of pigment with a much lower level of dyestuff colourant.

### RESIN VARIATION EXAMPLES

### Example 16

3.0 g of a nitrocellulose medium, containing 22% solids with the balance consisting of a 25:1 ratio of ethanol:ethyl acetate, is combined with 5.0 g ethanol, 0.75 g tall oil rosin and 0.25 g Basic Yellow 29 carbinol base. The system is then shaken till full solution is achieved. The resulting ink gives strong colouration on printing.

### Example 17

Example 16 is repeated with the tall oil rosin being replaced by maleic modified rosin giving similar results to example 16 on printing.

### SOLVENT VARIATION EXAMPLES

### Example 18

7.5 g tall oil rosin is dissolved in 20 ml ethanol by shaking. 3.0 g Basic Yellow 29 carbinol base is then added. Shaking results in full colouration of the solvent. Printing of this solution on aluminium foil reveals very high impact due to high strength, cleanliness and transparency.

### Example 19

Example 18 is repeated replacing the ethanol with ethyl acetate. Similar results to example 18 are achieved.

### Example 20

Example 18 is repeated replacing the ethanol with chloroform. Similar results to example 18 are achieved.

### Example 21

Example 18 is repeated replacing the ethanol with toluene. Similar results to example 18 are achieved.

### Example 22

3.0 g of tall oil rosin is added to 15 g ethanol and shaken giving a full solution. 1.0 g Basic Yellow 29 carbinol is then added and shaken giving full coluration to the solution. 10 g of a nitrocellulose medium, containing 22% solids with the balance consisting of a 25:1 ratio of ethanol:ethyl acetate, is then added. Printing of the ink reveals strong yellow colouration.

### Example 23

Example 22 is repeated replacing tall oil rosin with disproportionated rosin giving similar results.

### Example 24

Example 22 is repeated replacing tall oil rosin with hydrogenated rosin giving similar results.

### Example 25

Example 22 is repeated replacing tall oil rosin with polymerized abietic acid giving similar results.

### Example 26

Example 22 is repeated replacing ethanol with ethyl acetate. Printing of the ink reveals high colour strength plus high gloss and transparency.

### Example 27

Example 23 is repeated replacing ethanol with ethyl acetate. Printing of the ink reveals high colour strength plus high gloss and transparency.

### Example 28

Example 24 is repeated replacing ethanol with ethyl acetate. Printing of the ink reveals high colour strength plus high gloss and transparency.

### Example 29

Example 25 is repeated replacing ethanol with ethyl acetate. Printing of the ink reveals high colour strength plus high gloss and transparency.

### LITHOGRAPHIC EXAMPLES

### Example 30

To 5.0 g of a commercial lithographic heat-set ink varnish is added 0.25 g tall oil rosin. This mixture is carefully heated and stirred until the rosin melts and becomes homogenous with the varnish system. 0.50 g Basic Yellow 28 carbinol is then added. Heating and stirring is continued until a clear complete solution is obtained.

### Example 31

To 5.0 g of a commercial lithographic heat-set ink varnish is added 0.5 g tall oil rosin. This mixture is carefully heated and stirred until the rosin melts and becomes homogenous with the varnish system. 0.50 g Basic Yellow 28 carbinol is then added. Heating and stirring is continued until a clear complete solution is obtained.

### Example 32

To 5.0 g of a commercial lithographic heat-set ink varnish is added 1.0 g tall oil rosin. This mixture is carefully heated and stirred until the rosin melts and becomes homogenous with the varnish system. 0.50 g Basic Yellow 28 carbinol is then added. Heating and stirring is continued until a clear complete solution is obtained.

### Example 33

To 5.0 g of a commercial lithographic heat-set ink varnish is added 2.0 g tall oil rosin. This mixture is carefully heated and stirred until the rosin melts and becomes homogenous with the varnish system. 0.50 g Basic Yellow 28 carbinol is then added. Heating and stirring is continued until a clear complete solution is obtained.

Results

On printing, the inks from examples 30 to 33 give impart yellow colouration to the substrate with a level of transparency not normally possible with conventional pigments. In addition, example 33 gives extremely high gloss. Furthermore, the fluidity of the inks is much higher than conventional pigmented inks.

1. An organic solvent-based printing ink composition which comprises (1) one or more cationic dyestuff of formula (1), 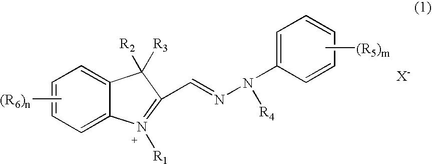
wherein R₁-R₆ are independently of one another hydrogen, substituted or unsubstituted alkyl, alkoxy, cycloalkyl, aryl, heteroaryl or allyl, R₂ and R₃ may be combined together to form a ring,
R₅ and R₆ are also independently of one another halogen, cyano, nitro, aryloxy, alkenyl, alkenoxy, alkoxcarbonyl, aryloxycarbonyl, acyloxy, acyl, alkylthio, arylthio, acylamino, alkylsulfonyl, arylsulfonyl or thiocyano, any two of R₅ or any two of R₆ may be combined together to form a homocyclic or heterocyclic aromatic or non-aromatic ring,
m is an integer of 1 to 5,
n is an integer of 1 to 4 and
X⁻ is an organic anion,
(2) an organic solvent,
(3) an organic resin acid, or a salt thereof, soluble in the organic solvent, and
(4) optionally a pigment.

2. The composition according to claim 1, wherein R₁-R₆ in the dyestuffs of formula (1) are independently of one another hydrogen, unsubstituted or substituted alkyl or alkoxy of 1 to 10 carbon atoms, cycloalkyl of 5 to 10 carbon atoms, aryl of 6 to 10 carbon atoms, heteroaryl of 5 to 10 atoms, comprising one or more nitrogen, oxygen or sulfur atoms as ring members, or allyl, R₂ and R₃ may be combined together to form a 5 to 7-membered ring.

3. A composition according to claim 2, wherein substituted alkyl comprises hydroxyalkyl, halogenoalkyl, aminoalkyl, cyanoalkyl or arylalkyl, substituted alkoxy comprises arylalkoxy, and aryl comprises phenyl or naphthyl, optionally substituted by hyroxy-, halogeno-, amino-, cyano-, carboxy-, carbonamido-, sulfo- or sulfonamido.

4. The composition according to claim 2, wherein R₁R₄ are methyl,
R₅ is methyl or methoxy when m is 1, or two R₅ together form —O—CH₂—O—CH₂—,
R₆ is hydrogen and
n is 1.

5. The composition according to claim 1, wherein X⁻ is the anion of an organic acid.

6. The composition according to claim 1, wherein the organic solvent (2) is one or more compounds selected from the group consisting of aliphatic hydrocarbons, halogenated aliphatic hydrocarbons, aromatic hydrocarbons, halogenated aromatic hydrocarbons, dialkylethers, glycol ethers, (non-polar) alcohols, esters, ketones, solubilising ink vehicle components and monomers (acrylate monomers).

7. The composition according to claim 5, wherein the resin acid (3) is an organo-soluble acid selected from the group consisting of rosin acid, abietyl resin, colophony or derivatives thereof.

8. The composition according to claim 1, which comprises
0.1-50% by weight of component (1),
1-95% % by weight of component (2),
0.1-75% of component (3), and
0-50% of component (4).

9. The composition according to claim 1 which additionally comprises an ink vehicle resin or binder.

10. The composition according to claim 1 wherein the organic solvent is a non-polar organic solvent.

11. The composition according to claim 1 wherein the printing ink composition is a gravure printing ink composition.

12. A process for the preparation of printing ink compositions according to claim 1 which process comprises mixing together
(a1) at least one carbinol dye precursor of the formula (2) 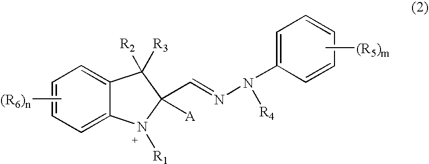
dissolved or dispersed in an organic solvent,
wherein R₁-R₆ are independently of one another hydrogen, substituted or unsubstituted alkyl, alkoxy, cycloalkyl, aryl, heteroaryl or allyl, R₂ and R₃ may be combined together to form a ring,
R₅ and R₆ are also independently of one another halogen, cyano, nitro, aryloxy, alkenyl, alkenoxy, alkoxcarbonyl, aryloxycarbonyl, acyloxy, acyl, alkylthio, arylthio, acylamino, alkylsulfonyl, arylsulfonyl or thiocyano,
any two of R₅ or any two of R₆ may be combined together to a homocyclic or heterocyclic aromatic or non-aromatic ring,
A is —OR, —N(R)₂, —N(R)COR, —N(R)SO₂R, —SR, —S(O)R, —O₂CR, —N(R)CON(R)₂, —OCON(R)₂, —SO₂N(R)₂ or —N(R)COOR, wherein R is R₁,
m is an integer of 1 to 5 and n is an integer of 1 to 4, with
(b) a solution of an organic resin acid, dissolved in an organic solvent, and with
(c) optionally a pigment.

13. The process according to claim 12, wherein R₁-R₆ in the carbinol dye precursor of formula (2) are independently of one another hydrogen, unsubstituted or substituted alkyl or alkoxy of 1 to 10 carbon atoms, cycloalkyl of 5 to 10 carbon atoms, aryl of 6 to 10 carbon atoms, heteroaryl of 5 to 10 atoms, comprising one or more nitrogen, oxygen or sulfur atoms as ring members, or allyl, R₂ and R₃ may be combined together to form a 5 to 7-membered ring.

14. A process for the preparation of gravure printing ink compositions according to claim 1 which process comprises mixing together
(a) at least one carbinol dye precursor of the formula (2) 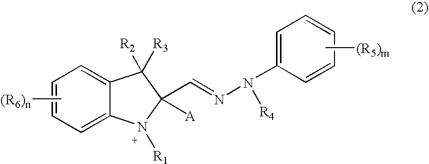
wherein R₁-R₆ are independently of one another hydrogen, substituted or unsubstituted alkyl, alkoxy, cycloalkyl, aryl, heteroaryl or allyl, R₂ and R₃ may be combined together to form a ring,
further R₅ and R₆ are also independently of one another halogen, cyano, nitro, aryloxy, alkenyl, alkenoxy, alkoxcarbonyl, aryloxycarbonyl, acyloxy, acyl, alkylthio, arylthio, acylamino, alkylsulfonyl, arylsulfonyl or thiocyano, any two of R₅ or any two of R₆ may be combined together to a homocyclic or heterocyclic aromatic or non-aromatic ring,
A is —OR, —N(R)₂, —N(R)COR, —N(R)SO₂R, —SR, —S(O)R, —O₂CR, —N(R)CON(R)₂, —OCON(R)₂, —SO₂N(R)₂ or —N(R)COOR, wherein R is R₁,
m is an integer of 1 to 5 and n is an integer of 1 to 4, with
(b) a solution of an organic resin acid, dissolved in an organic solvent, evaporating off the solvent (under reduced pressure) from that mixture until a dry mixture is obtained, and redissolving the dry mixture in an organic solvent compatible with the printing ink system, and with
(c) optionally an organic pigment.

15. The process according to claim 14, wherein R₁-R₆ in the carbinol dye precursor of formula (2) are independently of one another hydrogen, unsubstituted or substituted alkyl or alkoxy of 1 to 10 carbon atoms, cycloalkyl of 5 to 10 carbon atoms, aryl of 6 to 10 carbon atoms, heteroaryl of 5 to 10 atoms, comprising one or more nitrogen, oxygen or sulfur atoms as ring members, or allyl, R₂ and R₃ may be combined together to form a 5 to 7-membered ring.

16. The process according to claim 15, wherein R₁-R₄ are methyl,
R₅ is methyl or methoxy or two R₅ together form —O—CH₂—O—CH₂—,
R₆ is hydrogen,
A is —OH,
m is 1 or 2 and n is 1.

17. The process according to claim 12, wherein components (b) and (c) together constitute a resinated pigment.

18. The process according to claim 12, wherein the organic solvent for component (b) is one or more compounds selected from the group consisting of halogenated aliphatic hydrocarbons, halogenated aromatic hydrocarbons, dialkylethers, glycol ethers, alcohols, esters, ketones, solubilising ink vehicle components, monomers (acrylate monomers).

19. The process according to claim 14, wherein the organic solvent for component (b) is a member selected from the group consisting of halogenated aliphatic hydrocarbons, dialkylethers and ketones and the organic solvent for the redissolving step is a member selected form the group consisting of aromatic hydrocarbons, aliphatic alcohols and esters.

20. The process according to claim 14, which additionally comprises mixing an ink vehicle with components (a), (b) and optionally (c).

21. The process according to claim 14, which additionally comprises mixing an ink vehicle with the combined dry or redissolved components (a) and (b), and optionally component (c).

22. The process for the preparation of printing ink compositions according to claim 1, which comprises dry mixing components (a) with an organic (resin) acid, and optionally with component (c), and then co-dissolving this mixture in an organic solvent.

23. The dry mixture of components (a), the organic (resin) acid, and optionally (c), used in the process according to claim 22.

24. The co-dissolved mixture of components (a), the organic (resin) acid, and optionally (c) obtained according to claim 22.

25. The process according to claim 22, which comprises dry mixing components (a), the organic (resin) acid, and optionally (c), and an ink vehicle, and then co-dissolving this mixture in an organic solvent.

26. The dry mixture of components (a), the organic (resin) acid, optionally (c), and an ink vehicle used in the process according to claim 25.

27. The co-dissolved mixture of components (a), the organic (resin) acid, optionally (c), and an ink vehicle obtained according to the process of claim 25.

28. The process according to claim 22, which comprises incorporating components (a), the organic (resin) acid, and optionally (c) separately or as dry mix into preformed ink vehicles.

29. The process according to claim 25, which comprises extruding the components (a), the organic (resin) acid, and optionally (c) separately or as dry mix into high solids dispersions, solutions or pastes of the ink vehicles.

30. The extrusion products obtained according to the process of claim 29.

31. (canceled)

32. (canceled)

33. (canceled)

34. Process for printing which comprises printing a flat substrate with a printing ink composition according to claim 1.

35. Process for printing which comprises printing a flat substrate with a predominantly pigment based printing ink containing a composition according to any one of claim 1 as toning agents.

36. Process according to claim 34 wherein the printing process is a publication or packaging gravure, flexographic, lithographic or letterpress printing process.

37. The composition according to claim 5, wherein X⁻ is the anion of an organic resin acid.

38. Process according to claim 35 wherein the printing process is a publication or packaging gravure, flexographic, lithographic or letterpress printing process.
